(19) United States
(12) Patent Application Publication
(10) Pub. No.: US 2026/0305567 A1
(43) Pub. Date: Oct. 8, 2026

(54) Smart Pet Feeding System

(71) Applicant: Kathleen Santini, Augusta, MI (US)

(72) Inventor: Kathleen Santini, Augusta, MI (US)

(21) Appl. No.: 19/212,102

(22) Filed: May 19, 2025

Related U.S. Application Data
(60) Provisional application No. 63/782,111, filed on Apr. 2, 2025.

(51) Int. Cl. A01K 5/01; A01K 5/02

(52) U.S. Cl. CPC A01K 5/0142; A01K 5/025; A01K 5/0283; A01K 5/0291

(57) ABSTRACT

A smart pet feeding system is provided. The system is designed to provide individualized feeding control within multi-pet households by utilizing sensor technology and automated mechanisms. The smart pet feeding system comprises a bowl assembly comprising an internal receiving area for storing pet food in a sealed environment. Food is dispensed from the receiving area into a removable feeding tray via a dispensing chute, controlling food release in precise quantities. The user may configure portion sizes and feeding schedules using physical controls. A weighing sensor positioned beneath the tray measures the dispensed quantity to ensure alignment with user settings. A proximity sensor detects a specific RFID or NFC signal emitted by a tag attached to a pet's collar, activating a motorized lid mechanism to grant access solely to the designated pet. Upon the pet's departure, the lid closes and locks to prevent unauthorized access.

### CROSS-REFERENCE TO RELATED APPLICATION

The present application claims priority to, and the benefit of, U.S. Provisional Application No. 63/782,111, which was filed on Apr. 2, 2025, and is incorporated herein by reference in its entirety.

### FIELD OF THE INVENTION

The present invention relates generally to the field of animal feeding devices. More specifically, the present invention relates to a smart pet feeding system designed to provide individualized feeding control within multi-pet households by utilizing sensor technology and automated mechanisms. Accordingly, the present disclosure makes specific reference thereto. Nonetheless, it is to be appreciated that aspects of the present invention are also equally applicable to other like applications, devices, and methods of manufacture.

### BACKGROUND

In households with multiple pets, managing individualized feeding can present significant challenges. Pets often exhibit opportunistic behavior, leading them to consume food from bowls not designated for them. This creates problems such as unequal food distribution, dietary inconsistencies, and potential health risks if pets have specific nutritional needs or restrictions. For instance, certain pets may require special diets due to allergies, age, or medical conditions, and the unauthorized consumption of another pet's food can lead to adverse health effects. Moreover, manual supervision to ensure correct feeding is time-consuming and often impractical, particularly in busy households or when owners are absent. Traditional pet feeding bowls do not possess mechanisms to restrict access or monitor consumption, thereby failing to address these issues effectively. Automated feeders exist but typically lack the ability to differentiate between multiple pets. Therefore, there is a demand for a solution that offers controlled access to food based on pet identification while maintaining hygiene, accuracy, and convenience. Such a system must also be adaptable to various pet behaviors and environments to ensure reliable performance.

Therefore, there exists a long-felt need in the art for a smart pet feeding system that prevents multiple pets from accessing food not designated for them. There also exists a long-felt need in the art for a smart pet feeding system that enables accurate dispensing of food portions based on user-defined schedules or settings. Moreover, there exists a long-felt need in the art for a smart pet feeding system that maintains food freshness and ensures hygienic storage and delivery.

The subject matter disclosed and claimed herein, in one embodiment thereof, comprises a smart pet feeding system. The system is designed to provide individualized feeding control within multi-pet households by utilizing sensor technology and automated mechanisms. The smart pet feeding system comprises a bowl assembly comprising an internal receiving area for storing pet food in a sealed environment. Food is dispensed from the receiving area into a removable feeding tray via a dispensing chute, preferably funnel-shaped, to guide food accurately. The dispensing mechanism may comprise a motorized rotating auger or a gravity-assisted system with a motorized gate, controlling food release in precise quantities. The user may configure portion sizes and feeding schedules using physical controls. A weighing sensor positioned beneath the tray measures the dispensed quantity to ensure alignment with user settings. A proximity sensor detects a specific RFID or NFC signal emitted by a tag attached to a pet's collar, activating a motorized lid mechanism to grant access solely to the designated pet. Upon the pet's departure, the lid closes and locks to prevent unauthorized access.

In this manner, the smart pet feeding system of the present invention accomplishes all the foregoing objectives and provides a feeding device with pet-specific access to food, thereby preventing unauthorized feeding among multiple pets. The smart pet feeding system ensures accurate dispensing of food portions through user-configurable controls and integrated weighing sensors, addressing the need for precise dietary management. Furthermore, the system maintains food freshness through a sealed receiving area and automated lid mechanisms that minimize environmental exposure. By combining automated feeding control, pet identification, and hygienic food storage, the smart pet feeding system provides a comprehensive solution that effectively resolves the problems associated with multi-pet feeding environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart pet feeding system. The system is comprised of a smart pet-feeding system designed to allow individual pets in a multi-pet household to access only their designated food sources. The system is comprised of a bowl assembly that may include a non-slip bottom wall. The bowl assembly is further comprised of an internal receiving area for sealed food storage to maintain freshness and hygiene. The receiving area includes a lid in hinged, sliding, or removable configurations, with a gasket formed from flexible sealing materials to prevent air and moisture ingress. The receiving area may also include a transparent viewing window, enabling monitoring of food levels without opening the lid.

Food is dispensed from the receiving area into a removable feeding tray located at the base of the bowl assembly. A dispensing chute facilitates food transfer from the receiving area to the tray, preferably in a funnel shape to minimize spillage. The bowl assembly also includes a dispensing mechanism that regulates food release from the receiving area into the chute.

At least one control is provided for users to define portion sizes, feeding times, or initiate manual dispensing. The control may be comprised of physical interfaces or remote mobile applications. The control activates the dispensing mechanism to release a defined food quantity into the tray. The control correlates user-defined settings with the dispensing mechanism's operation, transmitting signals for accurate food release based on calculated durations or cycles. The control continuously monitors the dispensing mechanism for precise portion delivery. An internal weighing sensor measures the dispensed food to verify alignment with user settings. The weighing sensor, comprised of strain gauge load cells or piezoelectric elements, adjusts future dispensing for consistency.

A proximity sensor detects RFID or NFC signals from a tag attached to a pet's collar, allowing access only to the designated pet. The proximity sensor may be an active or passive RFID reader capable of distinguishing multiple tags. Upon detecting the tag, the proximity sensor activates a motorized lid mechanism, providing tray access. The lid mechanism, powered by a servo motor or linear actuator, includes obstacle detection for safety. When the pet finishes eating or moves out of range, the lid automatically closes and locks to prevent unauthorized access. The locking mechanism may be mechanical, magnetic, or electronic.

The system also includes a method of use, involving the setup of the bowl assembly, sealing pet food, configuring controls for dispensing, and enabling pet-specific access via proximity detection and automated lid control.

Accordingly, the smart pet feeding system of the present invention is particularly advantageous as it provides a feeding device with pet-specific access to food, thereby preventing unauthorized feeding among multiple pets. The smart pet feeding system ensures accurate dispensing of food portions through user-configurable controls and integrated weighing sensors, addressing the need for precise dietary management. Furthermore, the system maintains food freshness through a sealed receiving area and automated lid mechanisms that minimize environmental exposure. By combining automated feeding control, pet identification, and hygienic food storage, the smart pet feeding system provides a comprehensive solution that effectively resolves the problems associated with multi-pet feeding environments. In this manner, the smart pet feeding system overcomes the limitations of existing feeding solutions known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a smart pet feeding system of the present invention with the motorized lid open in accordance with the disclosed architecture;

FIG. 2 illustrates a perspective view of one potential embodiment of a smart pet feeding system of the present invention with the motorized lid open and a tray removed in accordance with the disclosed architecture;

FIG. 3 illustrates a perspective view of a tag of one potential embodiment of a smart pet feeding system of the present invention while attached to a pet collar in accordance with the disclosed architecture;

FIG. 4 illustrates a perspective view of one potential embodiment of a smart pet feeding system of the present invention with the motorized lid closed in accordance with the disclosed architecture; and

FIG. 5 illustrates a flowchart of a method of using one potential embodiment of a smart pet feeding system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a smart pet feeding system that prevents multiple pets from accessing food not designated for them. There also exists a long-felt need in the art for a smart pet feeding system that enables accurate dispensing of food portions based on user-defined schedules or settings. Moreover, there exists a long-felt need in the art for a smart pet feeding system that maintains food freshness and ensures hygienic storage and delivery.

The present invention, in one exemplary embodiment, is comprised of a smart pet feeding system. The system is comprised of a smart pet-feeding system designed to ensure that individual pets in a multi-pet household can access only their designated food sources. The system includes a bowl assembly, which may be comprised of a non-slip bottom wall. The bowl assembly is further comprised of an internal receiving area, designed for sealed food storage to preserve freshness and hygiene. The receiving area includes a lid configured as hinged, sliding, or removable, with a gasket formed from flexible sealing materials to block air and moisture ingress. Additionally, the receiving area may be provided with a transparent viewing window, allowing food levels to be monitored without opening the lid.

Food is dispensed from the receiving area into a removable feeding tray positioned at the base of the bowl assembly. A dispensing chute guides food from the receiving area into the tray, preferably funnel-shaped to minimize spillage. The bowl assembly further includes a dispensing mechanism that controls the release of food from the receiving area into the chute.

At least one control allows users to define portion sizes, set feeding times, or initiate manual dispensing. The control may be comprised of physical interfaces or remote mobile applications. The control operates the dispensing mechanism to deliver a defined quantity of food into the tray. The control aligns user-defined settings with the dispensing mechanism's function, sending signals for precise food release based on calculated durations or cycles. The control continuously oversees the dispensing mechanism to ensure accurate portion delivery. An internal weighing sensor measures the dispensed food to confirm alignment with user-defined settings. The weighing sensor, comprised of strain gauge load cells or piezoelectric elements, enables automatic adjustment of future dispensing for consistency.

A proximity sensor identifies RFID or NFC signals emitted by a tag attached to a pet's collar, restricting access to the designated pet. The proximity sensor may be an active or passive RFID reader capable of recognizing multiple tags. Upon signal detection, the proximity sensor triggers a motorized lid mechanism to allow tray access. The lid mechanism, driven by a servo motor or linear actuator, includes obstacle detection for safety. Once the pet finishes eating or leaves the detection range, the lid closes and locks automatically to block unauthorized access. The locking mechanism may be mechanical, magnetic, or electronically controlled.

The system further comprises a method of use, including assembling the bowl, sealing the food, configuring the control for dispensing, and enabling pet-specific access through proximity detection and automated lid operation.

As a result, the smart pet-feeding system described provides a feeding device offering pet-specific food access, effectively preventing unauthorized feeding in multi-pet environments. The system delivers accurate food portions through user-configurable controls and integrated weighing sensors, meeting precise dietary management needs. Additionally, the sealed receiving area and automated lid mechanism preserve food freshness by limiting environmental exposure. By integrating automated feeding control, pet identification, and hygienic food storage, the smart pet-feeding system presents a comprehensive solution that addresses challenges common in multi-pet feeding scenarios. In this way, the smart pet-feeding system overcomes limitations associated with existing feeding devices.

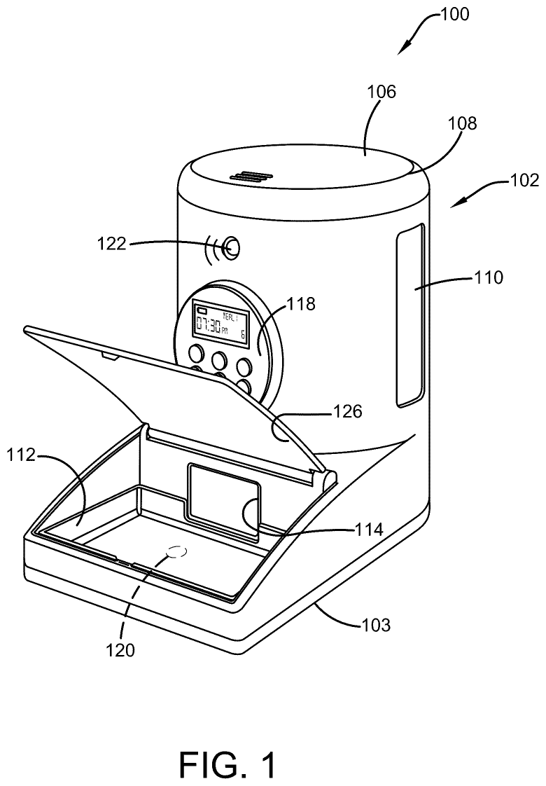

Referring initially to the drawings, FIG. 1 illustrates a perspective view of one potential embodiment of a smart pet feeding system 100 of the present invention with the motorized lid 126 open in accordance with the disclosed architecture. The system 100 is comprised of a smart pet-feeding system designed to ensure that individual pets within a multi-pet household exclusively access their designated food sources. More specifically, the system 100 is comprised of a bowl assembly 102. In one embodiment, the bowl assembly 102 is comprised of a non-slip bottom wall 103 comprised of, but not limited to, rubber, silicone, or thermoplastic elastomer materials, which provide enhanced grip and stability on various floor surfaces.

The bowl assembly 102 is further comprised of an internal receiving area 104 designed to store pet food in a sealed environment to maintain freshness and hygiene. The receiving area 104 is comprised of a lid 106 of any type such as, but not limited to, hinged, sliding, or removable configurations. In one embodiment, the lid 106 is comprised of a gasket 108 comprised of silicone, rubber, or other flexible sealing materials to prevent air and moisture from entering, thereby preserving the quality of the food stored within the receiving area 104.

The receiving area 104 may further be comprised of a transparent viewing window 110 that allows the user to monitor the remaining food levels without opening the lid 106, thus maintaining the sealed environment within the receiving area 104. The viewing window 110 may be comprised of clear plastic, glass, or other transparent materials suitable for food-safe applications.

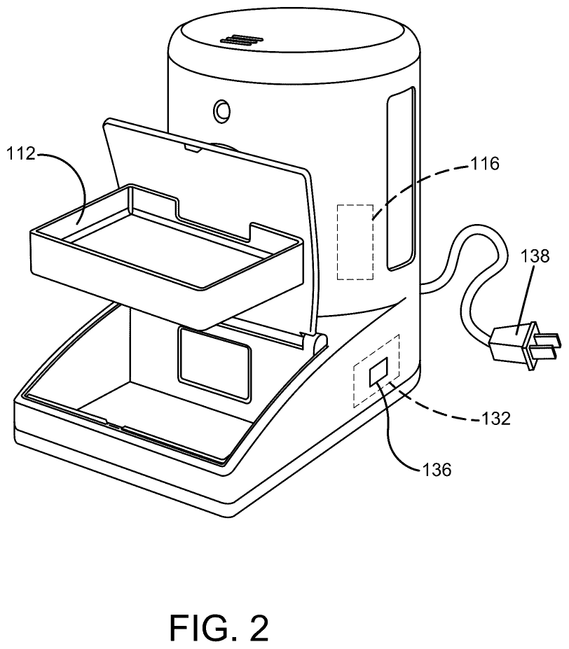

The food stored in the receiving area 104 is dispensed into a feeding tray 112 located at the base of the bowl assembly 102, as seen in FIG. 1. The tray 112 is designed to be removable (as seen in FIG. 2), allowing for convenient cleaning and maintenance. The tray 112 may be fabricated from BPA-free plastic, stainless steel, or other food-grade materials selected for durability and ease of sanitation.

The transfer of food from the receiving area 104 to the tray 112 occurs through a dispensing chute 114, as seen in FIG. 1. The dispensing chute 114 may be configured as any shape, but is preferably a funnel-shaped conduit, guiding the dry food through a controlled pathway to minimize spillage and ensure accurate delivery to the tray 112. The chute 114 may be comprised of plastic, stainless steel, or other rigid materials suitable for maintaining structural integrity during operation.

The bowl assembly 102 may further be comprised of a dispensing mechanism 116 designed to control the release of food from the receiving area 104 into the dispensing chute 114. The dispensing mechanism 116 may be in the form of a motorized rotating auger comprised of metal or reinforced plastic, which conveys a measured volume of food per rotation. In another embodiment, the dispensing mechanism 116 may be comprised of a gravity-assisted flow system incorporating a motorized gate or flap, allowing selective release of food. Alternative dispensing mechanisms 116 may include vibratory feeders, gear-driven systems, or spring-loaded hoppers, all configured to regulate the flow of food in precise amounts.

A user may define an amount of food to be dispensed from the receiving area 104 via the chute 114 by at least one control 118. The control 118 may be comprised of physical buttons, rotary dials, a touchscreen interface integrated into the bowl assembly 102, or may be remotely accessed in the form of a mobile application. The control 118 may allow a user to set specific portion sizes, schedule feeding times, or initiate manual dispensing. When the desired time occurs, as determined by the control 118, the dispensing mechanism 116 may be activated to dispense the selected amount of food into the tray 112.

The system 100 selects the defined amount of food by correlating the user-defined settings from the control 118 with operational parameters of the dispensing mechanism 116. Based on the portion size specified by the user, the control 118 transmits a signal to the dispensing mechanism 116 to operate for a calculated duration or number of cycles, corresponding to the preset volume of food. This process ensures that the dispensing mechanism 116 releases only the defined amount into the tray 112, regardless of the dispensing method employed. The control 118 continuously monitors the operation of the dispensing mechanism 116 to ensure accurate fulfillment of the defined food portion during each feeding event.

In one embodiment, the system 100 is comprised of an internal weighing sensor 120 that measures the dispensed food quantity to ensure accurate delivery according to the user's settings. The weighing sensor 120 may be comprised of strain gauge load cells or piezoelectric elements positioned beneath the tray 112 to detect the weight of the dispensed food. The data collected by the weighing sensor 120 may be processed to automatically adjust future dispensing cycles for consistency.

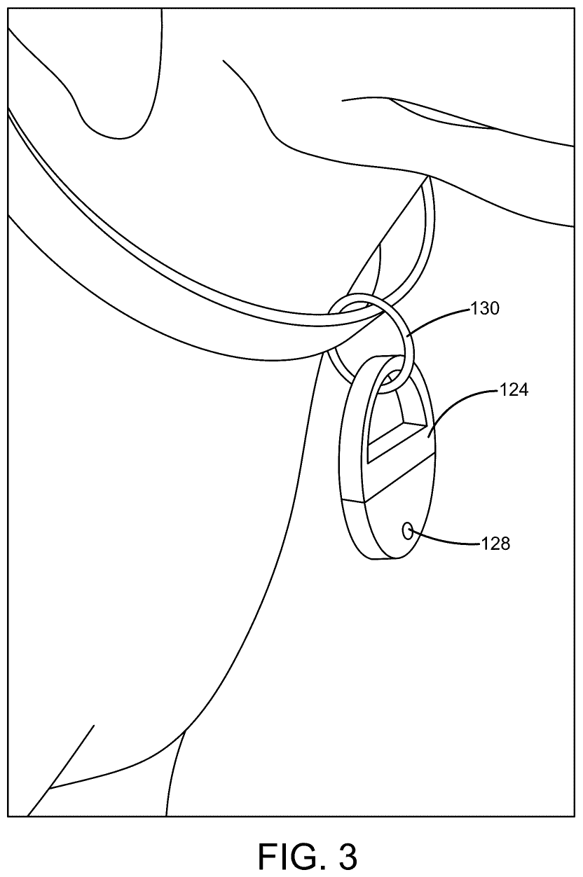

The bowl assembly 102 is further comprised of a proximity sensor 122 designed to recognize a specific RFID or NFC signal emitted by a tag 124 attached to a pet's collar, as seen in FIG. 3. The sensor 122 is calibrated to detect signals within a specific distance such as, but not limited to, 1 foot, ensuring that only the designated pet can access the food. The proximity sensor 122 may be in the form of an active or passive RFID reader, capable of discriminating between multiple tags to prevent cross-access in multi-pet environments.

Upon successful recognition of the tag 124, the sensor 122 activates a motorized lid mechanism 126 that opens (as seen in FIG. 1) to provide access to the tray 112. The motorized lid mechanism 126 may be comprised of a servo motor or linear actuator connected to a hinged or sliding cover. The lid mechanism 126 may include safety features such as obstacle detection sensors to prevent closure while the pet is feeding.

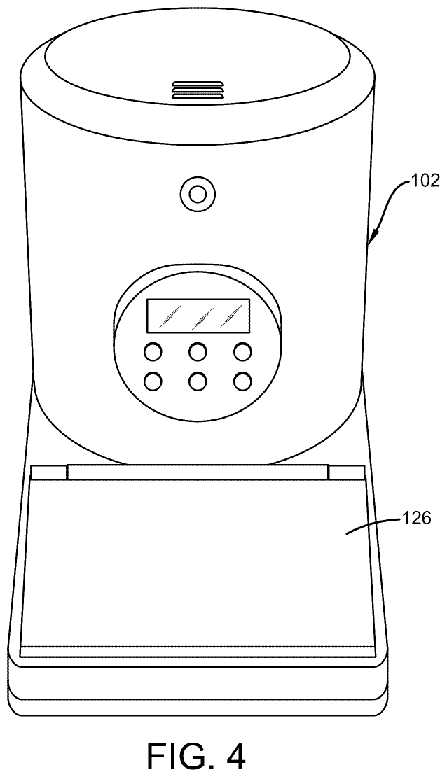

After the pet finishes eating or moves out of range of the sensor 122, the lid 126 automatically closes (as seen in FIG. 4) and locks to prevent unauthorized access. The locking mechanism may be mechanical, magnetic, or electronically controlled.

The tag 124 is further comprised of a sensor 128 such as, but not limited to, a temperature sensor, motion sensor, or accelerometer, providing additional functionalities such as activity tracking or health monitoring of the pet. The tag 124 may be comprised of a compact, lightweight housing suitable for continuous wear by the pet.

The tag 124 may be attached to the pet's collar using a fastener 130 such as, but not limited to, a snap buckle, hook and loop strap, or elastic loop, opening, etc., ensuring secure and adjustable attachment.

The system 100 may further be comprised of a power supply system 132 to provide electrical energy for operation of various components such as the dispensing mechanism 116, proximity sensor 122, motorized lid mechanism 126, and control 118. In one embodiment, the power supply system 132 is comprised of a rechargeable battery housed within the bowl assembly 102. The battery 132 may be comprised of lithium-ion, nickel-metal hydride, or other rechargeable chemistries suitable for long-term use and repeated charge cycles. Additionally, the power supply system 132 may be comprised of a charging port 136 integrated into the exterior surface of the bowl assembly 102. The charging port 136 may be configured to accept standard connectors, such as, but not limited to, USB-C, micro-USB, or barrel-type connectors, enabling convenient recharging of the battery 134. In another embodiment, the power supply system 132 may further be comprised of a power cord plug 138, allowing the system 100 to be connected directly to an electrical outlet for continuous operation or charging. The power cord plug 138 may be detachable or fixed and may include standard safety certifications for household electronic devices.

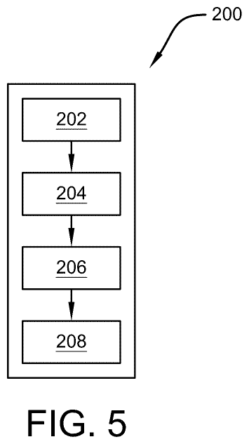

The present invention is also comprised of a method of using 200 the system 100, as seen in FIG. 5. First, a system 100 is provided comprised of a bowl assembly 102 comprised of a non-slip bottom wall 103, an internal receiving area 104 with a lid 106 and gasket 108, a transparent viewing window 110, a feeding tray 112, a dispensing chute 114, a dispensing mechanism 116, at least one control 118, a weighing sensor 120, a proximity sensor 122, a tag 124, a motorized lid mechanism 126, a sensor 128, and a fastener 130 [Step 202]. Then, pet food can be placed inside the receiving area 104, and the lid 106 can be secured to seal the food [Step 204]. Next, a user can configure the control 118 to define portion sizes, feeding schedules, or manual dispensing options either via physical control [Step 206]. The control 118 transmits signals to the dispensing mechanism 116 to dispense the defined amount of food into the tray 112 via the dispensing chute 114, with the weighing sensor 120 measuring the dispensed food for accuracy. Then, the tag 124 can be attached to a collar of a pet, and the collar can be securely fastened to the designated pet using the fastener 130 [Step 208]. As the pet approaches the bowl assembly 102, the proximity sensor 122 detects the RFID or NFC signal emitted by the tag 124 attached to the designated pet's collar within a predetermined range. Upon detection, the proximity sensor 122 activates the motorized lid mechanism 126 to open access to the tray 112 for the designated pet. After the pet finishes eating or leaves the proximity range, the motorized lid mechanism 126 automatically closes and locks to prevent access by other pets.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart pet feeding system” and “system” are interchangeable and refer to the smart pet feeding system 100 of the present invention.

Notwithstanding the foregoing, the smart pet feeding system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart pet feeding system 100 as shown in the FIGS. are for illustrative purposes only, and that many other sizes and shapes of the smart pet feeding system 100 are well within the scope of the present disclosure. Although the dimensions of the smart pet feeding system 100 are important design parameters for user convenience, the smart pet feeding system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A smart pet feeding system comprising:
a bowl assembly comprising an internal receiving area, a lid configured to seal the internal receiving area, a feeding tray, a dispensing chute configured to transfer food from the internal receiving area to the feeding tray, and a gravity-assisted flow dispensing mechanism configured to control release of the food from the internal receiving area into the dispensing chute;
a control configured to define an amount of a food to be dispensed by the gravity-assisted flow dispensing mechanism;
a strain gauge load cell weighing sensor;
a proximity sensor configured to recognize a signal emitted by a tag; and
a motorized lid mechanism configured to open to provide access to the feeding tray upon recognition of the signal by the proximity sensor.

2. The smart pet feeding system of claim 1, wherein the receiving area comprises a transparent viewing window.

3. (canceled)

4. (canceled)

5. The smart pet feeding system of claim 1, wherein the strain gauge load cell weighing sensor is positioned beneath the feeding tray.

6. (canceled)

7. The smart pet feeding system of claim 1, wherein the dispensing chute comprises a funnel-shaped dispensing chute.

8. The smart pet feeding system of claim 1, wherein the control comprises a physical button.

9. The smart pet feeding system of claim 1, wherein the control configures a portion size of the food dispensed to the feeding tray.

10. A smart pet feeding system comprising:
a bowl assembly comprising an internal receiving area, a lid configured to seal the internal receiving area comprised of a gasket, a feeding tray, a dispensing chute configured to transfer food from the internal receiving area to the feeding tray, and a vibratory dispensing mechanism configured to control release of the food from the internal receiving area into the dispensing chute;
a control configured to define an amount of a food to be dispensed by the vibratory dispensing mechanism;
an active RFID proximity sensor configured to recognize a signal emitted by a tag;
a motorized lid mechanism configured to open to provide access to the feeding tray upon recognition of the signal by the proximity sensor; and
a thermoplastic elastomer non-slip bottom wall.

11. (canceled)

12. The smart pet feeding system of claim 10, wherein the receiving area comprises a transparent viewing window.

13. (canceled)

14. The smart pet feeding system of claim 10 further comprising a weighing sensor.

15. The smart pet feeding system of claim 14, wherein the weighing sensor is positioned beneath the feeding tray.

16. (canceled)

17. The smart pet feeding system of claim 10, wherein the dispensing chute comprises a funnel-shaped dispensing chute.

18. The smart pet feeding system of claim 10, wherein the control comprises a touchscreen.

19. The smart pet feeding system of claim 10, wherein the control configures a portion size of the food dispensed to the feeding tray.

20. A method of using a smart pet feeding system, the method comprising the following steps:
providing a smart pet feeding system comprised of a bowl assembly comprising an internal receiving area with a lid, a feeding tray, a dispensing chute, a dispensing mechanism, a control, a weighing sensor, a proximity sensor, a tag, a motorized lid mechanism, a sensor, and a fastener;
placing a pet food inside the internal receiving area and securing the lid to seal the food within the internal receiving area;
configuring the control to define a portion size, a feeding schedule, or a manual dispensing option of the pet food; and
attaching the tag to a collar of a pet and fastening the collar to the designated pet using the fastener; and
wherein the tag is a NFC signal emitting tag detectable via the proximity sensor; and
wherein the tag comprises a temperature sensor.
